(19) United States
(12) Patent Application Publication
(10) Pub. No.: US 2015/0293719 A1
(43) Pub. Date: Oct. 15, 2015

(54) Storage Space Processing Method and Apparatus, and Non-Volatile Computer Readable Storage Medium

(71) Applicant: Huawei Technologies Co., Ltd., Shenzhen (CN)

(72) Inventors: Gang Luo, Shenzhen (CN); Xuewen Yuan, Shenzhen (CN)

(21) Appl. No.: 14/749,270

(22) Filed: Jun. 24, 2015

Related U.S. Application Data
(63) Continuation of application No. PCT/CN2012/087796, filed on Dec. 28, 2012.

(51) Int. Cl. G06F 3/06

(52) U.S. Cl. CPC G06F 3/0619; G06F 3/065; G06F 3/067; G06F 3/0665

(57) ABSTRACT

A storage space processing method and apparatus, and a non-volatile computer readable storage medium and relates to the field of data processing, which can improve utilization of storage space. The storage space processing method includes detecting usage of first storage space at a first interval, where the entire first storage space is set as common provisioning; and when it is determined that the usage of the first storage space is less than a first threshold at the first interval, releasing at least current free storage space. Embodiments of the present invention are mainly applied in a centralized storage control procedure.

### CROSS-REFERENCE TO RELATED APPLICATIONS

This application is a continuation of International Application No. PCT/CN2012/087796, filed on Dec. 28, 2012, which is hereby incorporated by reference in its entirety.

### TECHNICAL FIELD

The present invention relates to the field of data processing, and in particular, to a storage space processing method and apparatus, and a non-volatile computer readable storage medium.

### BACKGROUND

Currently, data storage management includes two methods: common provisioning and thin provisioning. A method for implementing common provisioning is configuring fixed storage space for operating systems or applications when a storage device is being initialized, where a capacity of already configured storage space does not change except in a case of reconfiguration.

In the prior art, a computer system or an application performs common provisioning according to a specific service when storage space is initially allocated, and cannot accurately determine required storage space, which causes redundancy and a waste of storage space of common provisioning.

### SUMMARY

Embodiments of the present invention provide a storage space processing method and apparatus, and a non-volatile computer readable storage medium, which can improve utilization of storage space.

To achieve the foregoing objective, the following technical solutions are used in the embodiments of the present invention.

According to a first aspect, the present invention provides a storage space processing method, including detecting usage of first storage space at a first interval, where the first storage space is set as common provisioning, and when the usage of the first storage space is less than a first threshold, releasing free storage space of the first storage space except second storage space; where the second storage space includes storage space that is already used to store data and is in the first storage space.

With reference to the first aspect, in a first possible implementation manner, the second storage space is specifically the storage space in which the data is stored, or the second storage space includes the storage space in which the data is stored, and free storage space in which a last logical block address into which data is written is used as a start offset address and N logical block addresses are offset; where N is a natural number, and the free storage space in which N logical block addresses are offset is not greater than the free storage space of the first storage space except the second storage space.

With reference to the first aspect or the first possible implementation manner of the first aspect, in a second possible implementation manner, the method further includes creating third storage space in the free storage space except the second storage space, where the third storage space is set as thin provisioning, and a capacity of the third storage space is a capacity of the free storage space except the second storage space, and setting a next logical block address of the last logical block address of the second storage space as a start logical block address of the third storage space.

According to a second aspect, the present invention provides a storage space processing method, including detecting usage of first storage space at a first interval, where the first storage space is set as common provisioning, when the usage of the first storage space is less than a first threshold, creating storage space of thin provisioning for the first storage space; where a capacity of the storage space of thin provisioning is a capacity of the first storage space, redirecting a write data operation from the first storage space to the storage space of thin provisioning, replicating data stored in the first storage space to the storage space of thin provisioning, and releasing the first storage space.

With reference to the second aspect, in a first possible implementation manner, after the releasing the first storage space, the method further includes detecting usage of the storage space of thin provisioning at a second interval, when the usage of the storage space of thin provisioning is not less than a second threshold, creating second storage space of common provisioning for the storage space of thin provisioning; where a capacity of the second storage space is the capacity of the storage space of thin provisioning, redirecting a write data operation from the storage space of thin provisioning to the second storage space, replicating data stored in the storage space of thin provisioning to the second storage space, and releasing the storage space of thin provisioning.

According to a third aspect, the present invention provides a storage space processing apparatus, including a detecting unit configured to detect usage of first storage space at a first interval, where the first storage space is set as common provisioning, and a releasing unit configured to, when the detecting unit determines that the usage of the first storage space is less than a first threshold, release free storage space of the first storage space except second storage space; where the second storage space includes storage space that is already used to store data and is in the first storage space.

With reference to the third aspect, in a first possible implementation manner, the second storage space is specifically the storage space in which the data is stored, or the second storage space includes the storage space in which the data is stored, and free storage space in which an address of a last logical block into which data is written is used as a start offset address and N logical block addresses are offset; where N is a natural number, and the free storage space in which N logical block addresses are offset is not greater than the free storage space of the first storage space except the second storage space.

With reference to the third aspect or the first possible implementation manner of the third aspect, in a second possible implementation manner, the apparatus further includes a creating unit configured to create third storage space in the free storage space except the second storage space, where the third storage space is set as thin provisioning, and a capacity of the third storage space is a capacity of the free storage space except the second storage space, and a determining unit configured to set a next logical block address of the last logical block address of the second storage space as a start logical block address of the third storage space.

According to a fourth aspect, the present invention provides a storage space processing apparatus, including a detecting unit configured to detect usage of first storage space at a first interval, where the first storage space is set as common provisioning, a creating unit configured to, when the detecting unit determines that the usage of the first storage space is less than a first threshold, create storage space of thin provisioning for the first storage space; where a capacity of the storage space of thin provisioning is a capacity of the first storage space, a redirecting unit configured to redirect a write data operation from the first storage space to the storage space of thin provisioning that is created by the creating unit, a replicating unit configured to replicate data stored in the first storage space to the storage space of thin provisioning that is created by the creating unit, and a releasing unit configured to release the first storage space.

With reference to the fourth aspect, in a first possible implementation manner, the detecting unit is further configured to detect usage of the storage space of thin provisioning at a second interval, the creating unit is further configured to, when the detecting unit determines that the usage of the storage space of thin provisioning is not less than a second threshold, create second storage space of common provisioning for the storage space of thin provisioning; where a capacity of the second storage space is the capacity of the storage space of thin provisioning, the redirecting unit is configured to redirect a write data operation from the storage space of thin provisioning to the second storage space that is created by the creating unit, the replicating unit is further configured to replicate data stored in the storage space of thin provisioning to the second storage space that is created by the creating unit, and the releasing unit is further configured to release the storage space of thin provisioning.

According to a fifth aspect, the present invention provides a storage space processing apparatus, including a memory and at least one central processing unit, where the memory is connected to the at least one central processing unit by using a bus, the memory is configured to store a computer instruction, and when the apparatus runs, the at least one central processing unit executes the computer instruction stored in the memory to enable the apparatus to execute the following operations: detecting usage of first storage space at a first interval, where the first storage space is set as common provisioning, and when the usage of the first storage space is less than a first threshold, releasing free storage space of the first storage space except second storage space; where the second storage space includes storage space that is already used to store data and is in the first storage space.

With reference to the fifth aspect, in a first possible implementation manner, the second storage space is specifically the storage space in which the data is stored, or the second storage space includes the storage space in which the data is stored, and free storage space in which an address of a last logical block into which data is written is used as a start offset address and N logical block addresses are offset; where N is a natural number, and the free storage space in which N logical block addresses are offset is not greater than the free storage space of the first storage space except the second storage space.

With reference to the fifth aspect or the first possible implementation manner of the fifth aspect, in a second possible implementation manner, the apparatus may further execute the following operations: creating third storage space in the free storage space except the second storage space, where the third storage space is set as thin provisioning, and a capacity of the third storage space is a capacity of the free storage space except the second storage space, and setting a next logical block address of the last logical block address of the second storage space as a start logical block address of the third storage space.

According to a sixth aspect, the present invention provides a storage space processing apparatus, including a memory and at least one central processing unit, where the memory is connected to the at least one central processing unit by using a bus, the memory is configured to store a computer instruction, and when the apparatus runs, the at least one central processing unit executes the computer instruction stored in the memory to enable the apparatus to execute the following operations: detecting usage of first storage space at a first interval, where the first storage space is set as common provisioning, when the usage of the first storage space is less than a first threshold, creating storage space of thin provisioning for the first storage space; where a capacity of the storage space of thin provisioning is a capacity of the first storage space, redirecting a write data operation from the first storage space to the storage space of thin provisioning, replicating data stored in the first storage space to the storage space of thin provisioning, and releasing the first storage space.

With reference to the sixth aspect, in a first possible implementation manner, the apparatus may further execute the following operations: after the step of the releasing the first storage space is executed, detecting usage of the storage space of thin provisioning at a second interval, when the usage of the storage space of thin provisioning is not less than a second threshold, creating second storage space of common provisioning for the storage space of thin provisioning; where a capacity of the second storage space is the capacity of the storage space of thin provisioning, redirecting a write data operation from the storage space of thin provisioning to the second storage space, replicating data stored in the storage space of thin provisioning to the second storage space, and releasing the storage space of thin provisioning.

According to a seventh aspect, the present invention provides a non-volatile computer readable storage medium, where the non-volatile computer readable storage medium stores a computer instruction, and a computer executes the computer instruction to execute the following operations: detecting usage of first storage space at a first interval, where the first storage space is set as common provisioning, and when the usage of the first storage space is less than a first threshold, releasing free storage space of the first storage space except second storage space; where the second storage space includes storage space that is already used to store data and is in the first storage space.

With reference to the seventh aspect, in a first possible implementation manner, the second storage space is specifically the storage space in which the data is stored, or the second storage space includes the storage space in which the data is stored, and free storage space in which an address of a last logical block into which data is written is used as a start offset address and N logical block addresses are offset; where N is a natural number, and the free storage space in which N logical block addresses are offset is not greater than the free storage space of the first storage space except the second storage space.

With reference to the seventh aspect or the first possible implementation manner of the seventh aspect, in a second possible implementation manner, the non-volatile computer readable storage medium may further execute the following operations: creating third storage space in the free storage space except the second storage space, where the third storage space is set as thin provisioning, and a capacity of the third storage space is a capacity of the free storage space except the second storage space, and setting a next logical block address of the last logical block address of the second storage space as a start logical block address of the third storage space.

According to an eighth aspect, the present invention provides a non-volatile computer readable storage medium, where the non-volatile computer readable storage medium stores a computer instruction, and a computer executes the computer instruction to execute the following operations: detecting usage of first storage space at a first interval, where the first storage space is set as common provisioning, when the usage of the first storage space is less than a first threshold, creating storage space of thin provisioning for the first storage space; where a capacity of the storage space of thin provisioning is a capacity of the first storage space, redirecting a write data operation from the first storage space to the storage space of thin provisioning, replicating data stored in the first storage space to the storage space of thin provisioning, and releasing the first storage space.

With reference to the eighth aspect, in a first possible implementation manner, the non-volatile computer readable storage medium may further execute the following operations: after the step of the releasing the first storage space is executed, detecting usage of the storage space of thin provisioning at a second interval, when the usage of the storage space of thin provisioning is not less than a second threshold, creating second storage space of common provisioning for the storage space of thin provisioning, where a capacity of the second storage space is the capacity of the storage space of thin provisioning, redirecting a write data operation from the storage space of thin provisioning to the second storage space, replicating data stored in the storage space of thin provisioning to the second storage space, and releasing the storage space of thin provisioning.

The present invention provides a storage space processing method and apparatus, and a non-volatile computer readable storage medium. Usage of first storage space is detected at a first interval, and when it is determined that the usage is less than a first threshold, current free storage space is released. In comparison with the prior art in which once storage space is set as common provisioning, a capacity of the storage space cannot be changed, and storage space that is actually required cannot be accurately determined, causing a problem of wasting a storage resource in a case of low usage, in the embodiments of the present invention, a capacity of storage space of common provisioning can be dynamically reduced by detecting usage of storage space, thereby improving utilization of the storage space.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a flowchart of a storage space processing method according to an embodiment of the present invention.

FIG. 2A is a structural diagram of dividing storage space according to an embodiment of the present invention.

FIG. 2B is another structural diagram of dividing storage space according to an embodiment of the present invention.

FIG. 2C is another structural diagram of dividing storage space according to an embodiment of the present invention.

FIG. 2D is another structural diagram of dividing storage space according to an embodiment of the present invention.

FIG. 3 is another flowchart of a storage space processing method according to an embodiment of the present invention.

FIG. 4 is another flowchart of a storage space processing method according to an embodiment of the present invention.

FIG. 5 is another flowchart of a storage space processing method according to an embodiment of the present invention.

FIG. 6A is another flowchart of a storage space processing method according to an embodiment of the present invention.

FIG. 6B is another structural diagram of dividing storage space according to an embodiment of the present invention.

FIG. 6C is another structural diagram of dividing storage space according to an embodiment of the present invention.

FIG. 7 is another flowchart of a storage space processing method according to an embodiment of the present invention.

FIG. 8 is a block diagram of a structure of a storage space processing apparatus according to an embodiment of the present invention.

FIG. 9 is another block diagram of a structure of a storage space processing apparatus according to an embodiment of the present invention.

FIG. 10 is another block diagram of a structure of a storage space processing apparatus according to an embodiment of the present invention.

FIG. 11 is another block diagram of a structure of a storage space processing apparatus according to an embodiment of the present invention.

### DESCRIPTION OF EMBODIMENTS

The following clearly describes the technical solutions in the embodiments of the present invention with reference to the accompanying drawings in the embodiments of the present invention. The described embodiments are merely some but not all of the embodiments of the present invention.

The present invention provides a storage space processing method and apparatus, and a non-volatile computer readable storage medium, which may be applied in a network architecture such as a storage area network (SAN). Centralized storage management, such as direct attached storage (DAS), or network attached storage (NAS) is generally used in the network architecture, that is, data of multiple servers is stored in one storage device for unified management. A storage management server detects current usage of storage space that is set as common provisioning to appropriately release parts that have not been used for a long time and are in storage space whose current usage is too low, so that these parts that have not been used for a long time can be used by another system or application, thereby improving utilization of the storage space.

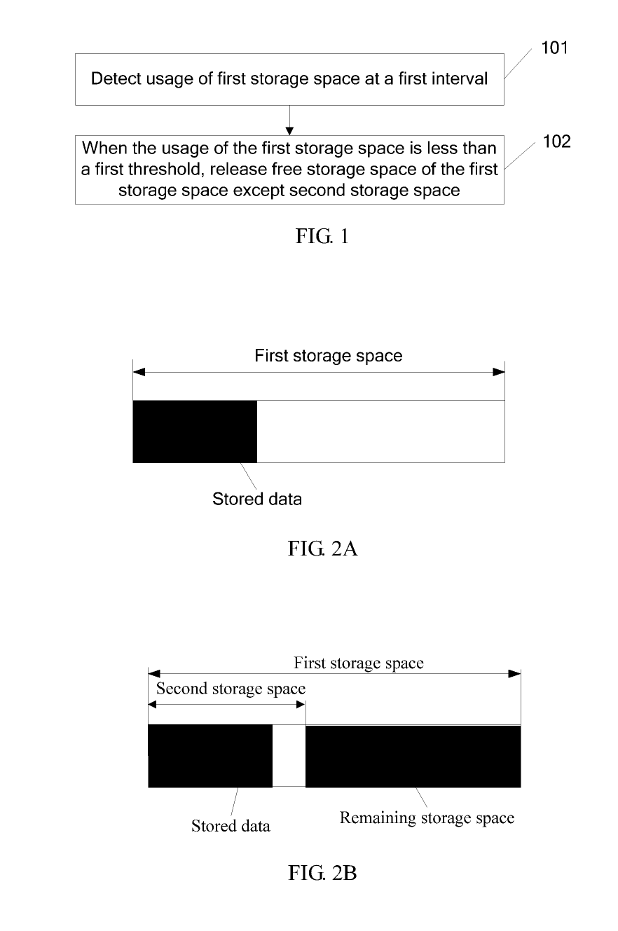

An embodiment of the present invention provides a storage space processing method, which, as shown in FIG. 1, includes:

101. Detect usage of first storage space at a first interval, where the first storage space is set as common provisioning.

The first interval may be set as required. For example, the first interval is set to 12 hours, 24 hours, or the like.

The usage of the first storage space may be a ratio of a capacity occupied by data stored in the first storage space to a rated capacity of the first storage space.

The entire first storage space is set as common provisioning.

102. When the usage of the first storage space is less than a first threshold, release free storage space of the first storage space except second storage space.

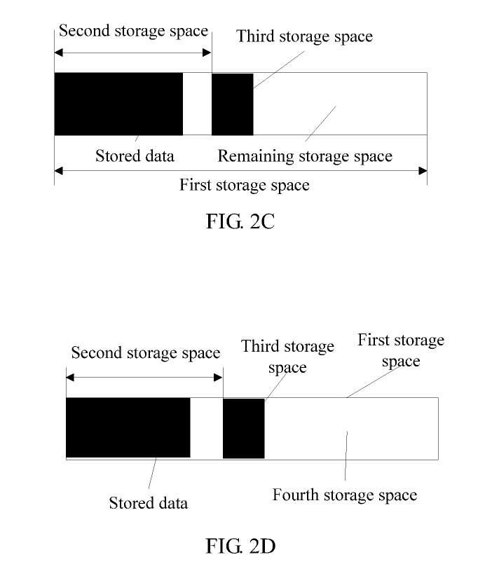

In this case, space occupied by the data stored in the first storage space is a part of the first storage space. For details, refer to a structural diagram of dividing storage space shown in FIG. 2A.

The second storage space includes storage space that is already used to store data and is in the first storage space, and the second storage space is specifically set in the following two manners:

In a first manner, the second storage space is the storage space in which the data is stored.

In a second manner, the second storage space includes the storage space in which the data is stored, and free storage space in which an address of a last logical block into which data is written is used as a start offset address and N logical block addresses are offset; where N is a natural number, and the free storage space in which N logical block addresses are offset is not greater than the free storage space of the first storage space except the second storage space. In this case, a storage device may be divided into second storage space and remaining storage space. Storage space occupied by currently stored data is a part of the second storage space. For details, refer to FIG. 2B.

In the first manner, the second storage space is space occupied by the data already stored in the first storage space.

In the second manner, a capacity of the second storage space is greater than a capacity of the space occupied by the data already stored in the first storage space, which mainly takes the following into consideration to prevent a written data loss: storage space that may be occupied by data written by an ongoing write operation.

The first threshold may be set according to a specific application scenario, for example, to 30% or 35%, and the present invention imposes no specific limitation thereon.

It is worth noting that, when it is determined that the usage of the first storage space is not less than the first threshold at the first interval, a detecting process in step 101 is continued to be executed.

In this embodiment of the present invention, usage of first storage space is detected at a first interval, and when it is determined that the usage is less than a first threshold, current free storage space is released. In comparison with the prior art in which once storage space is set as common provisioning, a capacity of the storage space cannot be changed, causing a problem of wasting a storage resource in a case of low usage, in this embodiment of the present invention, a capacity of storage space of common provisioning can be dynamically reduced by detecting usage of storage space, thereby improving utilization of the storage space.

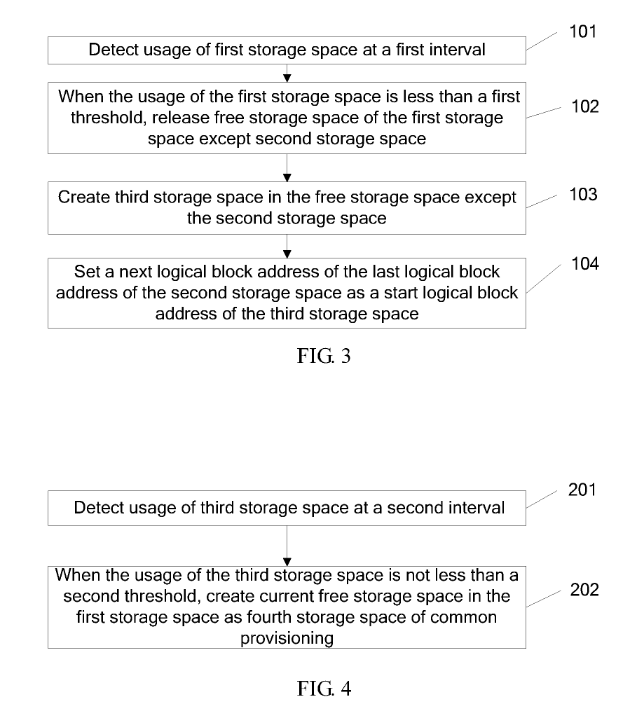

Based on a procedure of the method shown in FIG. 1, to ensure that a user can normally continue to write data, after step 102 is executed, a compact storage space needs to be further allocated in time according to an actual situation. This embodiment of the present invention further provides the following steps, which, as shown in FIG. 3, are:

103. Create third storage space in the free storage space except the second storage space.

The third storage space is set as thin provisioning. In addition, to ensure that, from a perspective of a user, a capacity of storage space allocated to the user does not change with release of the free storage space except the second storage space, a capacity of the third storage space needs to be set as a capacity of the free storage space except the second storage space. In a method for implementing thin provisioning, only a small fixed storage space is configured for operating systems or applications, and unallocated storage space is then dynamically allocated according to a subsequent service request of the operating systems or applications.

A person skilled in the art may know that the capacity of the third storage space of thin provisioning is set as the capacity of the free storage space except the second storage space, and the capacity of the free storage space except the second storage space herein refers to a capacity visible to a user. In an actual operation, a capacity actually allocated during creation of the third storage space only needs to be not greater than the capacity of the free storage space except the second storage space. A specific capacity may be set according to an actual requirement, and the capacity of the free storage space except the second storage space does not need to be actually allocated. In this case, as shown in FIG. 2C, the first storage space includes the second storage space, third storage space, and remaining storage space.

104. Set a next logical block address of the last logical block address of the second storage space as a start logical block address of the third storage space. Therefore, coherence at a bottom layer of the storage space is implemented.

It is worth noting that the last logical block address of the third storage space may be obtained by offsetting a particular quantity of logical block addresses from the start logical block address according to the capacity of the third storage space.

In implementation manners shown in FIG. 1 and FIG. 3, this embodiment of the present invention correspondingly provides methods for controlling data reading and writing.

A method for controlling a write operation includes when a size of to-be-written data is less than or equal to the capacity of the second storage space, storing the to-be-written data in the second storage space, and when the size of the to-be-written data is greater than the capacity of the second storage space, storing, in the second storage space, a part that is of the to-be-written data and does not exceed the capacity of the second storage space, and storing, in the third storage space, a part that is of the to-be-written data and exceeds the capacity of the second storage space.

A method for controlling a read operation includes reading stored data from the second storage space or the third storage space or both.

An objective of the foregoing steps 101 to 104 is to perform resource recycling if usage of storage space is relatively low. When the usage of the storage space gradually increases, another embodiment of the present invention further provides a method shown in FIG. 4, which is used to re-allocate the storage space, and includes:

201. Detect usage of the third storage space at a second interval. The usage of the third storage space is a percentage of a capacity of data already stored in the third storage space to the capacity of the third storage space, where the capacity of the third storage space refers to a capacity visible to a user. A person skilled in the art may know that, in an actual operation, the capacity of the third storage space of thin provisioning does not need to be actually allocated during creation of the third storage space. The second interval may be set as required, for example, to 3 days or 5 days, or may be set to be the same as the foregoing first interval. This embodiment of the present invention imposes no limitation thereon.

202. When the usage of the third storage space is not less than a second threshold, create current free storage space in the first storage space as fourth storage space of common provisioning.

The second threshold may be set according to a specific application scenario, for example, to 20%, and the present invention imposes no specific limitation thereon.

It is worth noting that, when it is determined that, the usage of the third storage space is less than the second threshold, a detecting process in step 301 is continued to be executed.

In this case, the storage device may be divided into the second storage space, the third storage space, and the fourth storage space. For details, refer to FIG. 2D.

In the method shown in FIG. 4, according to this embodiment of the present invention, storage space that has relatively low usage and is of common provisioning is replaced with storage space of thin provisioning, so that storage space that is originally redundant may be reused, which greatly improves usage of a data storage resource.

In addition, when usage of the storage space of thin provisioning is relatively high, the storage space is set as common provisioning again to accelerate a speed of writing and reading data and provide efficiency in reading and writing data.

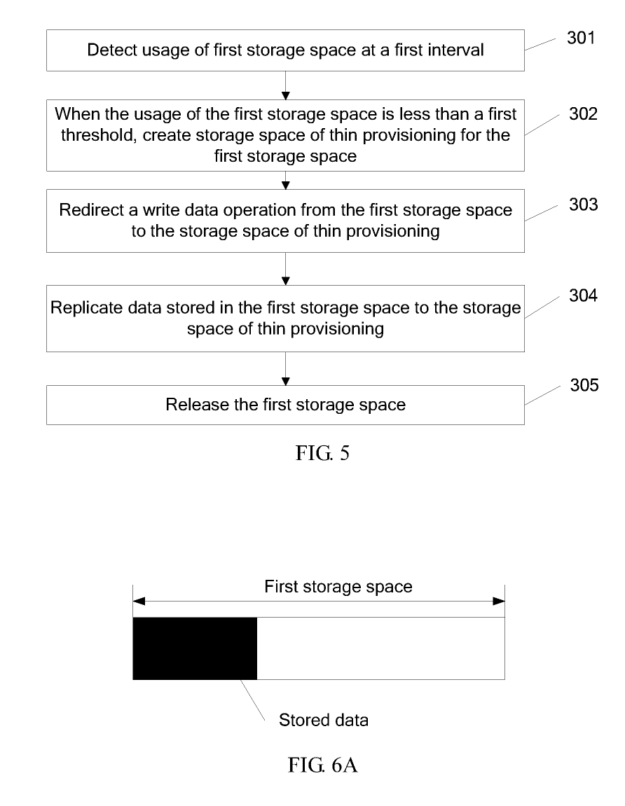

Another embodiment of the present invention further provides a storage space processing method, which, as shown in FIG. 5, includes:

301. Detect usage of first storage space at a first interval, where the first storage space is set as common provisioning.

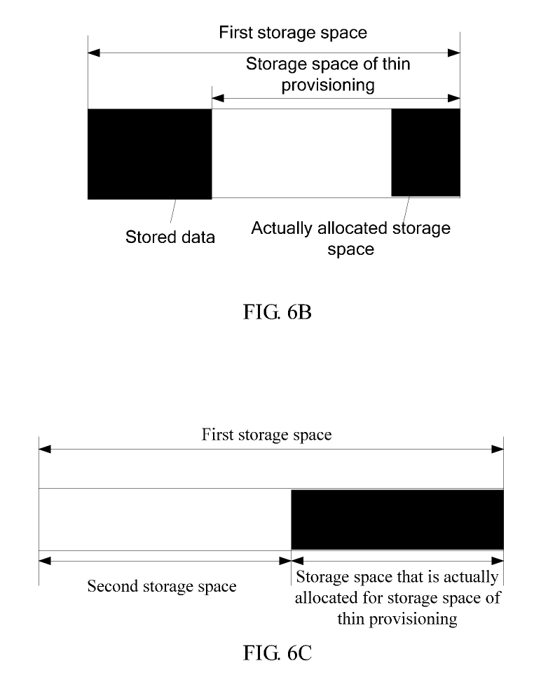

In this case, space occupied by data stored in the first storage space is a part of the first storage space. For details, refer to a structural diagram of dividing storage space shown in FIG. 6A.

A method for setting the first interval is the same as the related description in the foregoing step 101.

302. When the usage of the first storage space is less than a first threshold, create storage space of thin provisioning for the first storage space.

The storage space of thin provisioning may be created in other storage space independent of the first storage space. In this case, to ensure that, from a perspective of a user, a capacity of storage space allocated to the user does not change, a capacity of the storage space of thin provisioning needs to be set as a capacity of the first storage space. A person skilled in the prior art may know that, the capacity of the storage space of thin provisioning is herein set as the capacity of the first storage space, where the capacity of the storage space of thin provisioning is only a capacity visible to a user. In an actual operation, however, a capacity actually allocated during creation of the storage space of thin provisioning only needs to be not greater than the capacity of the first storage space, and a specific capacity may be set according to an actual requirement.

The storage space of thin provisioning may also be created in free storage space of the first storage space except the space occupied by the stored data. As shown in FIG. 6B, the first storage space includes both the space occupied by the stored data and the storage space of thin provisioning, and a capacity of the storage space of thin provisioning is only a capacity visible to a user. In an actual operation, however, a capacity of storage space actually allocated during creation of the storage space of thin provisioning only needs to be not greater than the capacity of the first storage space, and a specific capacity may be set according to an actual requirement.

A method for setting the first threshold is the same as the related description in the foregoing step 102.

303. Redirect a write data operation from the first storage space to the storage space of thin provisioning.

The redirecting a write data operation from the first storage space to the storage space of thin provisioning may implement storing newly written data in the storage space of thin provisioning instead of storing the newly written data in the first storage space.

304. Replicate data stored in the first storage space to the storage space of thin provisioning.

It is worth noting that, during a process of the replicating, an input-output (IO) interface location of data that has been replicated from the first storage space to the storage space of thin provisioning may be changed from a corresponding location of the first storage space to a corresponding location of the storage space of thin provisioning, and an IO interface location of data that has not been replicated from the first storage space to the storage space of thin provisioning still needs to retain the corresponding location of the first storage space.

305. Release the first storage space.

After the operation of replicating data in the first storage space to the storage space of thin provisioning is completed, the first storage space is released. In comparison with the prior art in which once storage space is set as common provisioning, a capacity of the storage space cannot be changed, causing a problem of wasting a storage resource in a case of low usage, in this embodiment of the present invention, a capacity of storage space of common provisioning can be dynamically reduced by detecting usage of storage space, thereby improving utilization of the storage space.

In implementation manners shown in FIG. 5, this embodiment of the present invention correspondingly provides methods for controlling data reading and writing.

A method for controlling a write operation includes storing to-be-written data in the storage space of thin provisioning.

A method for controlling a read operation includes reading stored data from the first storage space or the storage space of thin provisioning or both.

In the foregoing method for controlling a read operation, during a replication process, the data that has been replicated from the first storage space to the storage space of thin provisioning may be directly read from the storage space of thin provisioning, and the data that has not been replicated from the first storage space to the storage space of thin provisioning stills needs to be read from the first storage space. After the replication process ends, all data may be directly read from the storage space of thin provisioning.

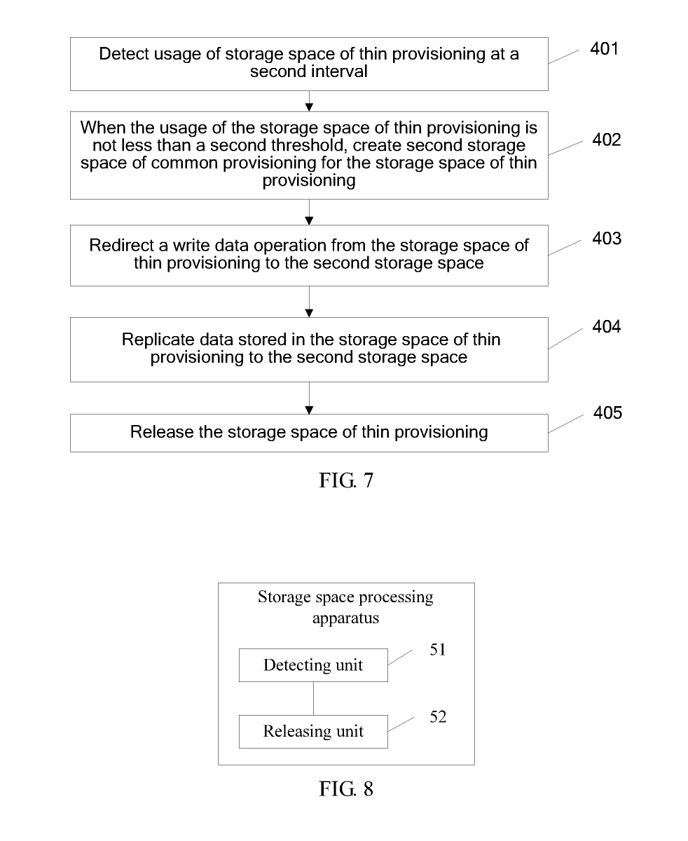

An objective of the foregoing steps 301 to 305 is to perform resource recycling if usage of storage space is relatively low. After steps 301 to 305 are executed and the usage of the storage space of thin provisioning gradually increases, another embodiment of the present invention further provides a method shown in FIG. 7, which is used to re-allocate the storage space, and includes:

401. Detect usage of the storage space of thin provisioning at a second interval.

The second interval may be set as required, for example, to 3 days or 5 days, or may be set to be the same as the foregoing first interval. This embodiment of the present invention imposes no limitation thereon. The usage of the storage space of thin provisioning is a percentage of a capacity of data already stored in the storage space of thin provisioning to the storage space of thin provisioning, where the capacity of the storage space of thin provisioning refers to a capacity visible to a user. A person skilled in the art may know that, in an actual operation, the capacity of the storage space of thin provisioning does not need to be actually allocated during creation of the storage space.

402. When the usage of the storage space of thin provisioning is not less than a second threshold, create second storage space of common provisioning for the storage space of thin provisioning.

The second storage space may be created in other storage space independent of the first storage space. A capacity of the second storage space is the capacity of the storage space of thin provisioning. For an objective and a method for setting the capacity of the second storage space, refer to the related description in step 302. A person skilled in the art may know that, a similarity between common provisioning and thin provisioning is that both the capacity of the second storage space and the capacity of the storage space of thin provisioning refer to capacities visible to a user, and a difference between common provisioning and thin provisioning is that the capacity of the storage space of thin provisioning needs to be actually allocated to the second storage space, and the capacity of the storage space of thin provisioning do not need to be actually allocated to the storage space of thin provisioning.

The second storage space may also be created in free storage space of the first storage space except space occupied by stored data. As shown in FIG. 6C, the first storage space includes both the second storage space and storage space that is actually allocated for storage space of thin provisioning. The second storage space is common provisioning, and remaining storage space of the first storage space except the storage space that is actually allocated for the storage space of thin provisioning is allocated to the second storage space.

It is worth noting that, when it is determined that the usage of the storage space of thin provisioning is less than the second threshold, a detecting process in step 401 is continued to be executed.

403. Redirect a write data operation from the storage space of thin provisioning to the second storage space.

A method for implementing redirection of a write operation is similar to the related description in step 303.

404. Replicate data stored in the storage space of thin provisioning to the second storage space.

405. Release the storage space of thin provisioning.

In the method shown in FIG. 7, according to this embodiment of the present invention, storage space that has relatively low usage and is of common provisioning is reduced, and a new thin provisioning is additionally allocated to stored data, so that storage space that is originally redundant may be reused, which greatly improves usage of a data storage resource.

In addition, when usage of storage space of thin provisioning is relatively high, storage space is additionally set as a new common provisioning to accelerate a speed of writing and reading data and improve efficiency of reading and writing data.

Another embodiment of the present invention provides a storage space processing apparatus, which may be configured to implement the procedures of the methods shown in FIG. 1 to FIG. 4. As shown in FIG. 8, the apparatus includes a detecting unit 51 configured to detect usage of first storage space at a first interval, where the first storage space is set as common provisioning, and a releasing unit 52 configured to, when the detecting unit 51 determines that the usage of the first storage space is less than a first threshold, release free storage space of the first storage space except second storage space; where the second storage space includes storage space that is already used to store data and is in the first storage space.

The second storage space is specifically the storage space in which the data is stored; or the second storage space includes the storage space in which the data is stored, and free storage space in which an address of a last logical block into which data is written is used as a start offset address and N logical block addresses are offset; where N is a natural number, and the free storage space in which N logical block addresses are offset is not greater than the free storage space of the first storage space except the second storage space.

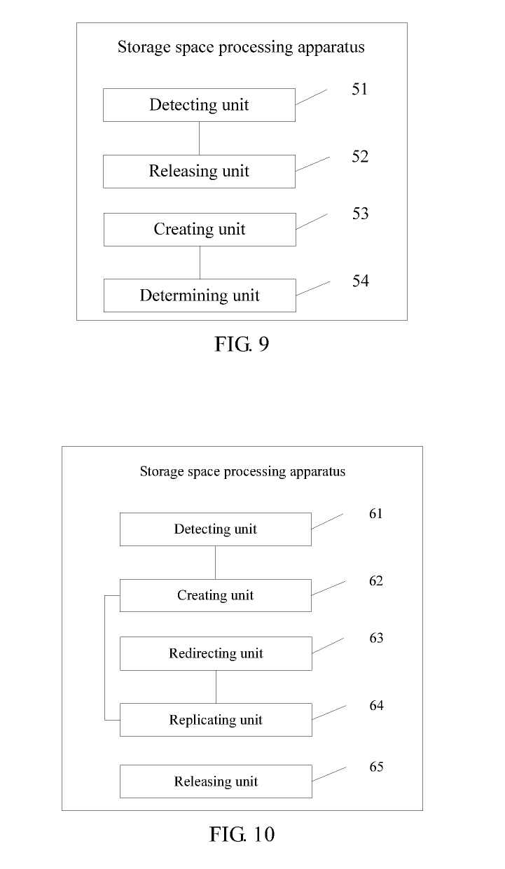

Optionally, as shown in FIG. 9, the apparatus further includes a creating unit 53 configured to create third storage space in the free storage space except the second storage space, where the third storage space is set as thin provisioning, and a capacity of the third storage space is a capacity of the free storage space except the second storage space, and a determining unit 54 configured to set a next logical block address of the last logical block address of the second storage space as a start logical block address of the third storage space created by the creating unit 53.

Optionally, the detecting unit 51 is further configured to detect usage of the third storage space at a second interval.

The creating unit 53 is further configured to, when the detecting unit 51 detects that the usage of the third storage space is not less than a second threshold, create current free storage space of the first storage space as fourth storage space of common provisioning.

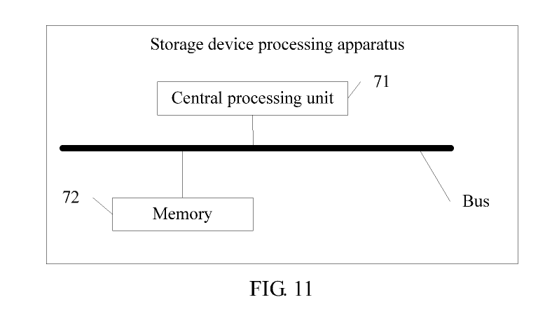

Another embodiment of the present invention further provides a storage space processing apparatus, which may be configured to implement the procedures of the methods shown in FIG. 5 to FIG. 7. As shown in FIG. 10, the apparatus includes a detecting unit 61 configured to detect usage of first storage space at a first interval, where the first storage space is set as common provisioning, a creating unit 62 configured to, when the detecting unit 61 determines that the usage of the first storage space is less than a first threshold, create storage space of thin provisioning for the first storage space, where a capacity of the storage space of thin provisioning is a capacity of the first storage space, a redirecting unit 63 configured to redirect a write data operation from the first storage space to the storage space of thin provisioning that is created by the creating unit 62, a replicating unit 64 configured to replicate data stored in the first storage space to the storage space of thin provisioning that is created by the creating unit 62, and a releasing unit 65 configured to release the first storage space.

Optionally, the detecting unit 61 is further configured to detect usage of the storage space of thin provisioning at a second interval.

The creating unit 62 is further configured to, when the detecting unit 61 detects that the usage of the storage space of thin provisioning is not less than a second threshold, create second storage space of common provisioning for the storage space of thin provisioning. A capacity of the second storage space is the capacity of the storage space of thin provisioning.

The redirecting unit 63 is configured to redirect a write data operation from the storage space of thin provisioning to the second storage space that is created by the creating unit 62.

The replicating unit 64 is further configured to replicate data stored in the storage space of thin provisioning to the second storage space that is created by the creating unit 62.

The releasing unit 65 is further configured to release the storage space of thin provisioning.

The present invention provides a storage space processing apparatus. Usage of first storage space may be detected at a first interval, and when it is determined that the usage is less than a first threshold, current free storage space is released. In comparison with the prior art in which once storage space is set as common provisioning, a capacity of the storage space cannot be changed, causing a problem of wasting a storage resource in a case of low usage, in this embodiment of the present invention, a capacity of storage space of common provisioning can be dynamically reduced by detecting usage of storage space, thereby improving utilization of the storage space.

Referring to FIG. 11, another embodiment of the present invention further provides a storage device processing apparatus whose function is the same as that of the apparatus shown in FIG. 8. The apparatus shown in FIG. 11 includes at least one central processing unit 71 and a memory 72. The memory 72 is connected to the at least one central processing unit 71 by using a bus, the memory 72 is configured to store a computer instruction, and when the apparatus runs, the at least one central processing unit 71 executes the computer instruction stored in the memory 72 so that the apparatus executes the procedures of the methods shown in FIG. 1 to FIG. 4.

Based on a structure of the apparatus shown in FIG. 11, another embodiment of the present invention may further implement the procedures of the methods shown in FIG. 5 to FIG. 7.

The present invention provides a storage space processing apparatus. Usage of first storage space may be detected at a first interval, and when it is determined that the usage is less than a first threshold, current free storage space is released. In comparison with the prior art in which once storage space is set as common provisioning, a capacity of the storage space cannot be changed, causing a problem of wasting a storage resource in a case of low usage, in this embodiment of the present invention, a capacity of storage space of common provisioning can be dynamically reduced by detecting usage of storage space, thereby improving utilization of the storage space.

For descriptions related to the apparatus in this embodiment of the present invention, refer to descriptions of corresponding method embodiments, and details are not described herein again.

Based on the foregoing descriptions of the implementation manners, a person skilled in the art may clearly understand that the present invention may be implemented by software in addition to necessary universal hardware or by hardware only. In most circumstances, the former is a preferred implementation manner. Based on such an understanding, the technical solutions of the present invention essentially or the part contributing to the prior art may be implemented in a form of a software product. The software product is stored in a readable storage medium, such as a floppy disk, a hard disk or an optical disc of a computer, and includes several instructions for instructing a computer device (which may be a personal computer, a server, or a network device) to perform the methods described in the embodiments of the present invention.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A storage space processing method implemented by a computer, comprising:
detecting, by the computer, usage of a first storage space at a first interval, wherein the first storage space is set as common provisioning; and
releasing, by the computer, free storage space of the first storage space except a second storage space when the usage of the first storage space is less than a first threshold, wherein the second storage space comprises a storage space that is already used to store data and is in the first storage space.

2. The method according to claim 1, wherein the second storage space is the storage space in which the data is stored.

3. The method according to claim 1, wherein the second storage space comprises the storage space in which the data is stored, and free storage space in which a last logical block address into which data is written is used as a start offset address and N logical block addresses are offset, wherein N is a natural number, and wherein the free storage space in which the N logical block addresses are offset is not greater than the free storage space of the first storage space except the second storage space.

4. The method according to claim 1, further comprising:
creating, by the computer, a third storage space in the free storage space except the second storage space, wherein the third storage space is set as thin provisioning, and wherein a capacity of the third storage space is a capacity of the free storage space except the second storage space; and
setting, by the computer, a next logical block address of the last logical block address of the second storage space as a start logical block address of the third storage space.

5. A storage space processing method implemented by a computer, comprising:
detecting, by the computer, usage of a first storage space at a first interval, wherein the first storage space is set as common provisioning;
creating, by the computer, storage space of thin provisioning for the first storage space when the usage of the first storage space is less than a first threshold, wherein a capacity of the storage space of thin provisioning is a capacity of the first storage space;
redirecting, by the computer, a write data operation from the first storage space to the storage space of thin provisioning;
replicating, by the computer, data stored in the first storage space to the storage space of thin provisioning; and
releasing, by the computer, the first storage space.

6. The method according to claim 5, further comprising:
detecting, by the computer, usage of the storage space of the thin provisioning at a second interval;
creating, by the computer, a second storage space of common provisioning for the storage space of thin provisioning when the usage of the storage space of thin provisioning is not less than a second threshold, wherein a capacity of the second storage space is the capacity of the storage space of the thin provisioning;
redirecting, by the computer, a write data operation from the storage space of the thin provisioning to the second storage space;
replicating, by the computer, data stored in the storage space of the thin provisioning to the second storage space; and
releasing, by the computer, the storage space of the thin provisioning.

7. A storage space processing apparatus, comprising:
a processor; and
a memory, wherein the processor is configured to execute computer-executable instructions stored in the memory to perform operations of:
detecting usage of a first storage space at a first interval, wherein the first storage space is set as common provisioning; and
releasing a free storage space of the first storage space except a second storage space when the usage of the first storage space is less than a first threshold, wherein the second storage space comprises a storage space that is already used to store data and is in the first storage space.

8. The storage space processing apparatus according to claim 7, wherein the second storage space is the storage space in which the data is stored.

9. The storage space processing apparatus according to claim 7, wherein the second storage space comprises the storage space in which the data is stored, and the free storage space in which a last logical block address into which data is written is used as a start offset address and N logical block addresses are offset, wherein N is a natural number, and wherein the free storage space in which the N logical block addresses are offset is not greater than the free storage space of the first storage space except the second storage space.

10. The storage space processing apparatus according to claim 7, wherein the processor is further configured to perform operations of:
creating a third storage space in the free storage space except the second storage space, wherein the third storage space is set as thin provisioning, and wherein a capacity of the third storage space is a capacity of the free storage space except the second storage space; and
setting a next logical block address of the last logical block address of the second storage space as a start logical block address of the third storage space.

11. A storage space processing apparatus, comprising:
a processor; and
a memory, wherein the processor is configured to execute computer-executable instructions stored in the memory to perform operations of:
detecting usage of a first storage space at a first interval, wherein the first storage space is set as common provisioning;
creating a storage space of thin provisioning for the first storage space when the usage of the first storage space is less than a first threshold, wherein a capacity of the storage space of the thin provisioning is a capacity of the first storage space;
redirecting a write data operation from the first storage space to the storage space of the thin provisioning;
replicating data stored in the first storage space to the storage space of the thin provisioning; and
releasing the first storage space.

12. The storage space processing apparatus according to claim 11, wherein the processor is further configured to perform operations of:
detecting usage of the storage space of the thin provisioning at a second interval;
creating a second storage space of common provisioning for the storage space of thin provisioning when the usage of the storage space of thin provisioning is not less than a second threshold, wherein a capacity of the second storage space is the capacity of the storage space of the thin provisioning;
redirecting a write data operation from the storage space of the thin provisioning to the second storage space;
replicating data stored in the storage space of the thin provisioning to the second storage space; and
releasing the storage space of the thin provisioning.

13. A non-volatile computer readable storage medium, wherein the non-volatile computer readable storage medium stores computer instructions, and wherein a computer executes the computer instructions to execute the following operations:
detecting usage of a first storage space at a first interval, wherein the first storage space is set as common provisioning; and
releasing a free storage space of the first storage space except a second storage space when the usage of the first storage space is less than a first threshold, wherein the second storage space comprises a storage space that is already used to store data and is in the first storage space.

14. The non-volatile computer readable storage medium according to claim 13, wherein the computer executes the computer instructions to further execute the following operations:
creating a third storage space in the free storage space except the second storage space, wherein the third storage space is set as thin provisioning, and wherein a capacity of the third storage space is a capacity of the free storage space except the second storage space; and
setting a next logical block address of the last logical block address of the second storage space as a start logical block address of the third storage space.

15. A non-volatile computer readable storage medium, wherein the non-volatile computer readable storage medium stores computer instructions, and wherein a computer executes the computer instructions to execute the following operations:
detecting usage of a first storage space at a first interval, wherein the first storage space is set as common provisioning;
creating a storage space of thin provisioning for the first storage space when the usage of the first storage space is less than a first threshold, wherein a capacity of the storage space of the thin provisioning is a capacity of the first storage space;
redirecting a write data operation from the first storage space to the storage space of the thin provisioning;
replicating data stored in the first storage space to the storage space of the thin provisioning; and
releasing the first storage space.

16. The non-volatile computer readable storage medium according to claim 15, wherein the computer executes the computer instructions to further execute the following operations:
detecting usage of the storage space of the thin provisioning at a second interval;
creating a second storage space of common provisioning for the storage space of thin provisioning when the usage of the storage space of thin provisioning is not less than a second threshold, wherein a capacity of the second storage space is the capacity of the storage space of thin provisioning;
redirecting a write data operation from the storage space of the thin provisioning to the second storage space;
replicating data stored in the storage space of the thin provisioning to the second storage space; and
releasing the storage space of the thin provisioning.
